(19) United States
(12) Patent Application Publication
(10) Pub. No.: US 2015/0144275 A1
(43) Pub. Date: May 28, 2015

(54) BLIND SYSTEM

(71) Applicant: HOLIS INDUSTRIES LTD., Afula Ilit (IL)

(72) Inventor: Yacov Ganzi, Kfar Neter (IL)

(73) Assignee: HOLIS INDUSTRIES LTD., Afula Ilit (IL)

(21) Appl. No.: 14/412,764

(22) PCT Filed: Jul. 4, 2013
(86) PCT No.: PCT/IL2013/050572

§ 371 Date: Jan. 5, 2015

(30) Foreign Application Priority Data
Jul. 5, 2012 (IL) 220779

(51) Int. Cl. E06B 9/32; E06B 9/382; E06B 9/303; E06B 9/384

(52) U.S. Cl. CPC E06B 9/32; E06B 9/384; E06B 9/382; E06B 9/303
USPC 160/84.03

(57) ABSTRACT

Provided is a blind system including a head-rail; a first cord mechanism associated with a first blind portion via a first cord; a second cord mechanism associated with a second blind portion via a second cord; each blind portion includes a bottom rail; the first blind portion is interposed between the headrail and the second blind portion, where the second cord is also associated with the first blind portion.

### FIELD

This invention relates to control mechanisms for blinds, more particularly to a single controller mechanism used with dual-stage blinds.

### BACKGROUND

Venetian blinds are very commonly used for shielding window and door openings to block the passage of light and to provide privacy. Generally, blinds comprise a plurality of horizontally extending members (slats in Venetian type blinds, pleats in Plisse or pleated blinds etc.), parallel to one another.

Typically, raising and lowering of the slats is facilitated by pulling a cord attached to a mechanism that engages the cord to lock the location of the slats at a desired elevation.

Conventional blinds incorporate a looped cord attached to a mechanism inside the blind that moves the slats/pleats, and can be pulled to selectively open or close the blind vanes. Such looped cords hang free from one side of the blind, and the necessary length of the looped cord depends on the width of the opening.

Some blinds comprise two portions, each having different shading characteristics, allowing the user to choose the desired manner of shading. In particular, the arrangement is usually such that one of the portions can be raised/lowered while the other is maintained in a retracted position and vise versa.

### GENERAL DESCRIPTION

According to one aspect of the disclosed subject matter there is provided a blind system comprising a head-rail with a first cord mechanism associated with a first blind portion via a first cord and a second cord mechanism associated with a second blind portion via a second cord, each blind portion comprising a bottom rail, said first blind portion being interposed between said headrail and said second blind portion, wherein said second cord is also associated with said first blind portion.

The bottom rail of the first blind portion can be interposed between slats/pleats of the first blind portion and slats/pleats of the second blind portion.

Each of the cord mechanisms can be constituted by a spool on which the first and second cord are configured for winding respectively. The first and the second cord each have a proximal end fixedly attached to the respective spool and a distal end configured for attachment to a bottom rail of its respective blind portion.

Each spool can assume a first, fully retracted position in which the cord is fully wound on the spool in a predetermined direction (either CW or CCW) so that the distal end of the respective cord is most adjacent to its respective spool and a second, fully deployed position in which the cord is fully unwound from the spool so that the distal end of the respective cord is most remote from its respective spool.

Respectively, said bottom rail can also assume a first, proximal position in which it is at its most proximal location with respect to the headrail, and a second, distal position in which it is at its most distal location with respect to the headrail. As blinds are typically used in a vertical orientation and are facilitated by gravity and the weight of the bottom rail itself, in such a vertical configuration, the distal and proximal positions of the bottom rail are respectively a lowermost position and an upper most position.

In addition, at least the first spool is configured for assuming a third, backward retracted position in which the cord is fully wound on the spool in a direction opposite to the predetermined direction (i.e. if in the first, fully retracted position the cord is wound in a CW direction, in the third, backward retracted position, the cord is fully wound on the spool in a CCW direction). It is important to note that in both the first and the third positions, the distal end of the first cord is also most adjacent to its respective spool.

In connection with the above, it is appreciated that the first, second and third positions of at least the first spool are consecutive in operation, i.e. from the first, fully retracted position, rotation of the spool in the predetermined direction will bring the spool to its second, fully deployed position, and further rotation of the spool in the same direction will cause the cord to wind on the spool in the opposite direction, bringing it to the third, backward retracted position.

The first cord and the second cord can be of different lengths, specifically, the second cord can be longer than the first cord, so that upon simultaneous rotation of both spools, the first spool reaches its second, fully deployed position before the second spool still has a portion of the second cord wound thereon.

Thus, upon further rotation of the spools in the same direction, the first spool begins displacing from the second, fully deployed position to the third, backward retracted position, while the second spool is still in rotation to unwind the cord therefrom.

The ratio between the lengths of the cords provides for a unique operation of the blind system, determining the timing of displacement between positions of the first and of the second spool. In particular, the arrangement can be such that the first cord is of length L while the second cord is of length 1.5 L, whereby when the first spool reaches its third, backward retracted position, the second spool reaches its second, deployed position.

In operation, the arrangement can be such that during winding/unwinding of the cord, each cord progresses through an opening of the headrail, so as to bring the bottom rail, to which the distal end of the cord is attached, closer/farther from the headrail.

The second cord, being longer than the first cord as suggested above, can be provided with a stopper disposed along the cord and configured for preventing a portion of the cord from being extracted through the opening of the headrail. Specifically, the stopper can be disposed between the distal end and the proximal end of the cord so as to divide the cord into an inner portion, defined between the proximal end and the stopper and an outer portion defined between the stopper and the distal end.

The arrangement can be such that the stopper is located within the headrail so as to allow full extraction of the outer portion of the cord outside the headrail and preventing extraction of the inner portion from the headrail, maintaining it therein. However, it is noted that the stopper does not prevent the second cord from being unwound from the second spool.

In addition, the headrail and spool can be provided with a winding mechanism configured for preventing entanglement of the inner portion of the second cord within the headrail when the second spool is in its second, fully deployed position.

In particular, the winding mechanism can be constituted by a spool shell having block elements extending from the shell towards the spool. The block elements are configured for preventing entanglement of the inner portion of the cord when the spool in unwound.

More particularly, owing to the above arrangement, the second spool is also configured for assuming a third, backward position in which the inner portion of the cord is wound in the opposite direction on the spool. When the stopper has reached the opening of the headrail (i.e. the outer portion is outside the headrail), further rotation of the spool will cause not only unwinding of the inner portion from the spool but also winding of the same inner portion on the spool in the opposite direction. Specifically, the end of the inner portion fixed to the stopper begins unwinding while the end of the inner portion fixed to the spool begins winding in the opposite direction.

According to a particular example, the stopper can be disposed on the second cord to divide it such that the outer portion of the second cord is of a 2:1 ratio, i.e. the outer portion is 1.5 times as long as the inner portion. Under this example, the distal end of both the first cord and of the second cord can reach an equivalent maximal distance L from the headrail, entailing an equivalent maximal distance of the bottom rail of each of the blind portions from the headrail.

In operation, from an initial position in which both the first spool and the second spool are in their first, fully retracted position, the blind system can perform at least the following stages (for a first cord of length L and a second cord of length 1.5 L):

Initial deployment—both spools are rotated in order to unwind their respective cords, gradually displacing from the first, fully retracted position towards the second, deployed position, until the first spool reaches its second, fully deployed position. At the end of the initial deployment, the distal end of the first cord is at its maximal distance from the headrail, and both bottom rails of each of the blind portions are at a distance L from the headrail;

First retraction—upon further rotation of the spools in the same direction, the first cord is wound on the first spool in a direction opposite to the initial direction of winding, while the inner portion of the second cord begins winding on the second spool in the opposite direction. In this position, the bottom rail of the first blind portion gradually progresses towards the headrail, while the bottom rail of the second blind portion remains in place, due to the stopper preventing further extraction of the second cord through the headrail. This is performed until the first spool reaches its third, backward retracted position, which, due to the length ratios is timed with the third, backward position of the second spool;

Initial retraction—both spools are rotated in an opposition direction, leading to displacement of the first spool from the third, backward retracted position back to the second, fully deployed position, and displacement of the inner portion of the second cord from the third, backward position to the second, unwound position. Consequently, the bottom rail of the first blind portion is displaced to its most remote position from the headrail; and

Full retraction—upon further rotation of the spools, both the first and the second cord are wound on their respective spools, bringing both, simultaneously, to the first, fully retracted position.

The first blind portion can be provided with a plurality of first blind elements (e.g. slats/pleats) extending between the first bottom rail and the headrail and the second blind portion can be provided with a plurality of second blind elements (slats/pleats) extending between the first bottom rail and the second bottom rail.

The plurality of first blind elements and second blind elements can be of different characteristics, whereby each of the blind portions has different shading characteristics. For example, the first blind portion can be a pleated blind configured for allowing passage of a predetermined amount of light and the second blind portion can be a double-pleated blind configured for obstructing more light than the first portion.

The arrangement can be such that the second cord extends from the second spool to the second bottom rail via designated openings in the first bottom rail, whereby displacement of the second bottom rail towards the headrail entails displacement of the first bottom rail towards the same upon contact between the bottom rails.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIGS. 1A to 1C are schematic isometric, front and side views of a blind system according to the subject matter of the present application;

FIG. 2A is a schematic enlarged isometric views of detail A shown in FIGS. 1A to 1C, depicting a cord mechanism used in the blind system;

FIG. 2B is a schematic enlarged view of a portion of a headrail of the blind system shown in FIGS. 1A to 1C;

FIG. 2C is a schematic enlarged isometric view of detail B shown in FIG. 1A;

FIG. 3A is a schematic isometric view of the blind system shown in FIGS. 1A to 1C, with half the each of the top and of the bottom blind portion being removed;

FIG. 3B is a schematic isometric view of the blind system shown in FIG. 3A, with a top and a bottom portion of the blind being removed as well;

FIGS. 4A to 4D are schematic isometric views of the blind system shown in FIGS. 1A to 1C, during four consecutive positions of operation of the blind system;

FIG. 5A is a schematic exploded isometric view of a spool of the bottom blind portion shown in FIGS. 1A to 1C;

FIG. 5B is a schematic isometric view of the spool shown in FIG. 5A, when assembled, with a casing thereof being shown in phantom lines;

FIG. 5C is a schematic isometric view of an inner portion of the spool shown in FIG. 5B;

FIG. 5D is a schematic enlarged view of detail C shown in FIG. 5C;

FIG. 5E is a schematic isometric view of a spool of the top blind portion shown in FIGS. 1A to 1C, with a casing thereof being shown in phantom lines;

FIG. 5F is a schematic isometric view of an inner portion of the spool shown in FIG. 5E;

FIG. 5G is a schematic enlarged view of detail D shown in FIG. 5F;

FIG. 5H is a schematic enlarged view of detail E shown in FIG. 4A;

FIG. 6A is a schematic isometric view of the spool of the bottom blind portion shown in FIG. 4B, with a casing thereof being shown in phantom lines;

FIG. 6B is a schematic isometric view of an inner portion of the spool shown in FIG. 6A;

FIG. 6C is a schematic enlarged view of detail F shown in FIG. 6B;

FIG. 6D is a schematic enlarged sectioned view of a detail G shown in FIG. 6A;

FIG. 6E is a schematic isometric view of the spool of the top blind portion shown in FIG. 4B, with a casing thereof being shown in phantom lines;

FIG. 6F is a schematic isometric view of an inner portion of the spool shown in FIG. 6E;

FIG. 7A is a schematic isometric view of the spool of the bottom blind portion shown in FIG. 4C, with a casing thereof being shown in phantom lines;

FIG. 7B is a schematic isometric view of an inner portion of the spool shown in FIG. 7A;

FIG. 7C is a schematic enlarged view of detail H shown in FIG. 7B;

FIG. 7D is a schematic enlarged sectioned view of a detail I shown in FIG. 6A;

FIG. 7E is a schematic isometric view of the spool of the top blind portion shown in FIG. 4C, with a casing thereof being shown in phantom lines;

FIG. 7F is a schematic isometric view of an inner portion of the spool shown in FIG. 7E;

FIG. 8A is a schematic isometric view of the spool of the bottom blind portion shown in FIG. 4D, with a casing thereof being shown in phantom lines;

FIG. 8B is a schematic isometric view of an inner portion of the spool shown in FIG. 8A;

FIG. 8C is a schematic enlarged view of detail J shown in FIG. 8B;

FIG. 8D is a schematic enlarged sectioned view of a detail K shown in FIG. 8A;

FIG. 8E is a schematic isometric view of the spool of the top blind portion shown in FIG. 4B, with a casing thereof being shown in phantom lines;

FIG. 8F is a schematic isometric view of an inner portion of the spool shown in FIG. 8E;

### DETAILED DESCRIPTION OF EMBODIMENTS

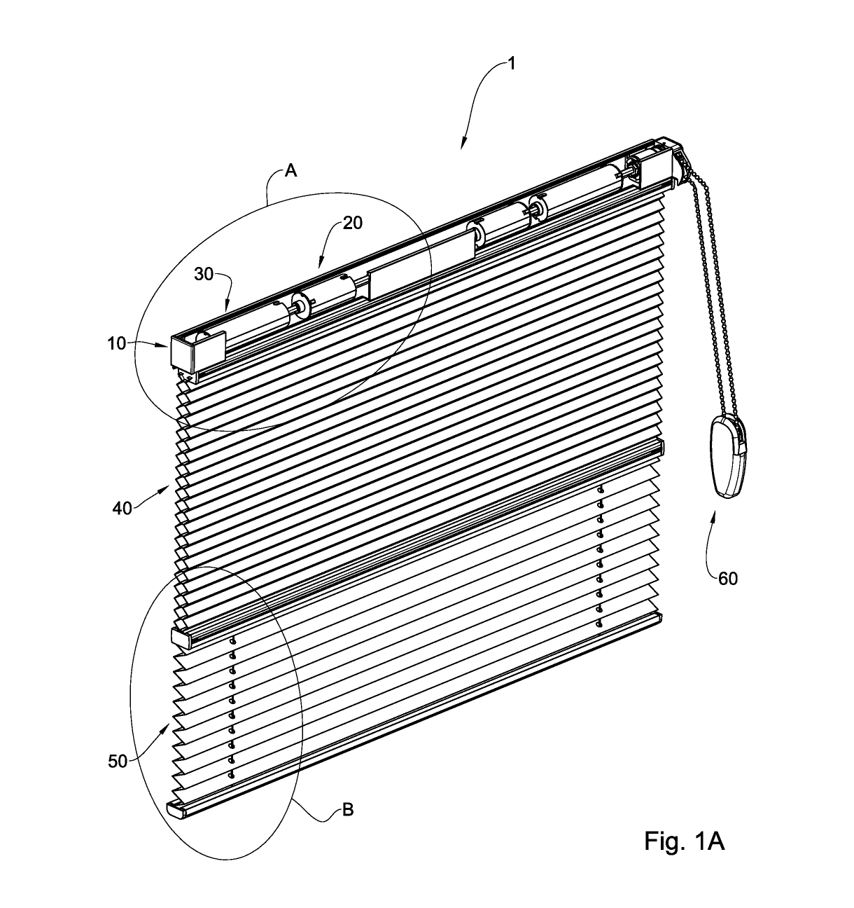

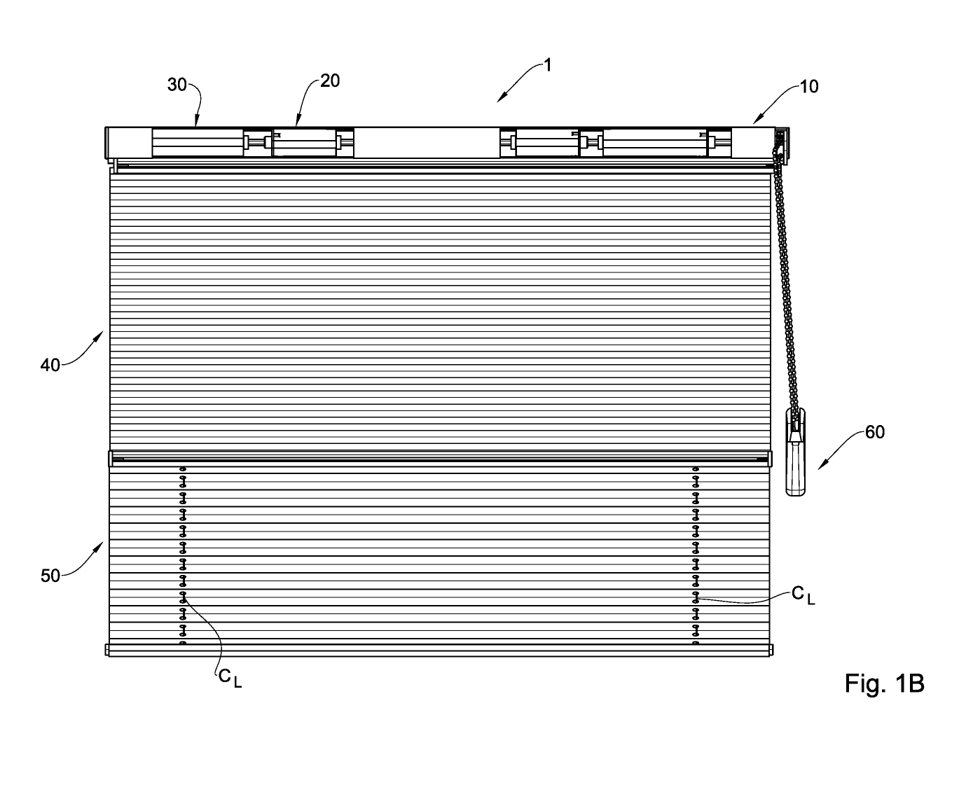

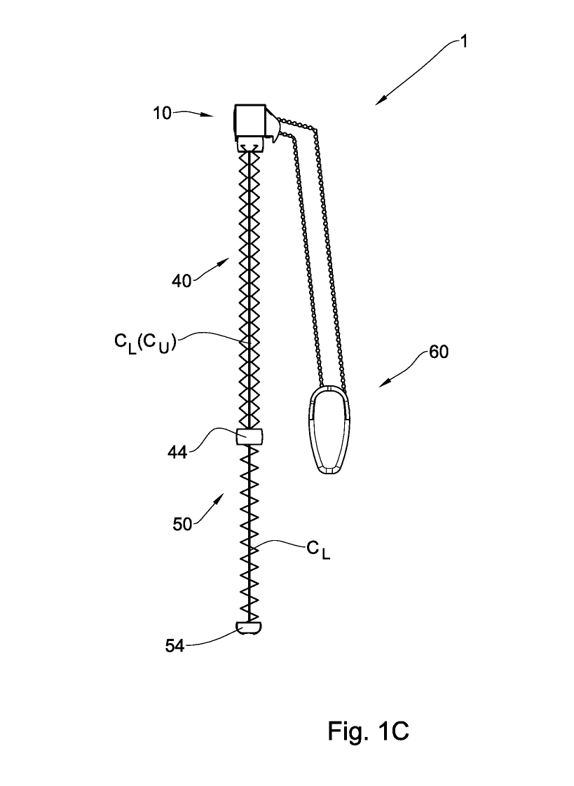

Turning first to FIGS. 1A to 1C, a two-stage blind system is shown, generally designated as 1. The blind system 1 comprises a headrail 10 accommodating an upper cord mechanism 20 and a lower cord mechanism 30, respectively associated with an upper blind portion 40 and a lower blind portion 50. The cord mechanisms 20, 30 are positioned along a mutual axis X and are manually operated via an activation mechanism 60.

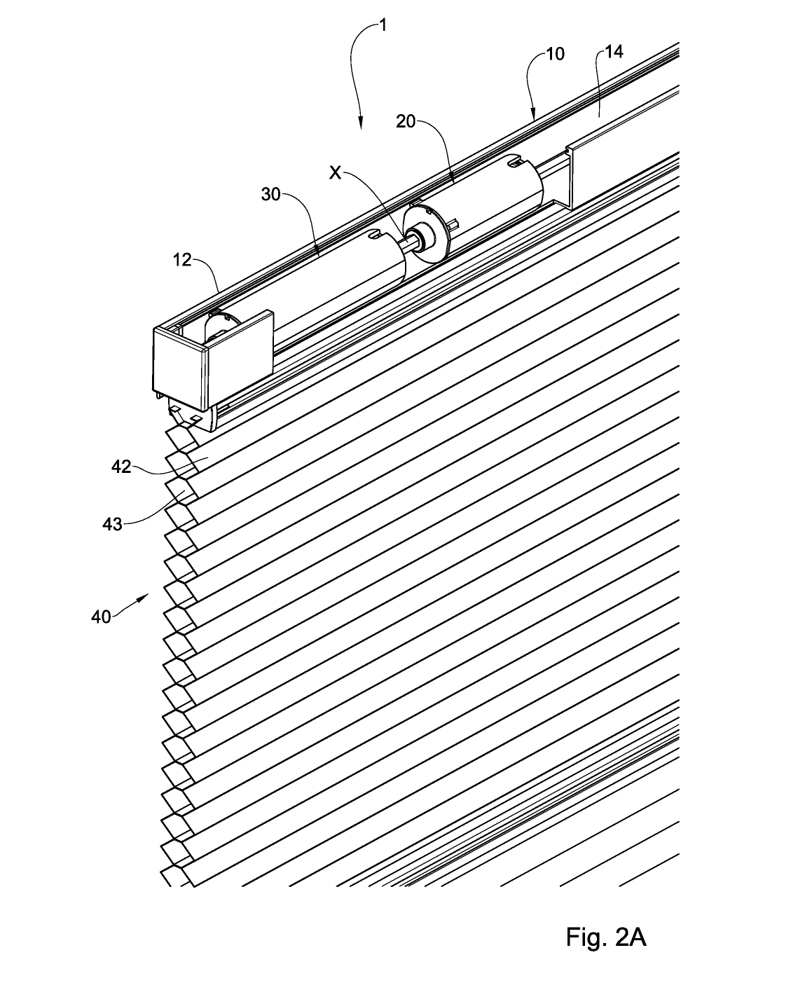

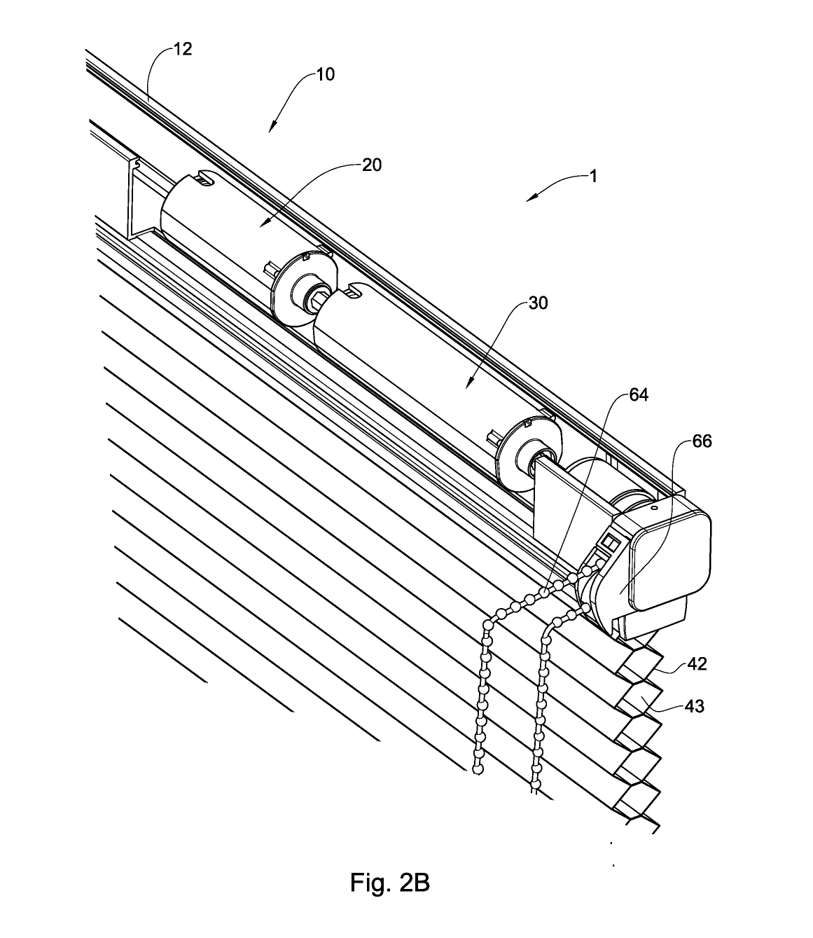

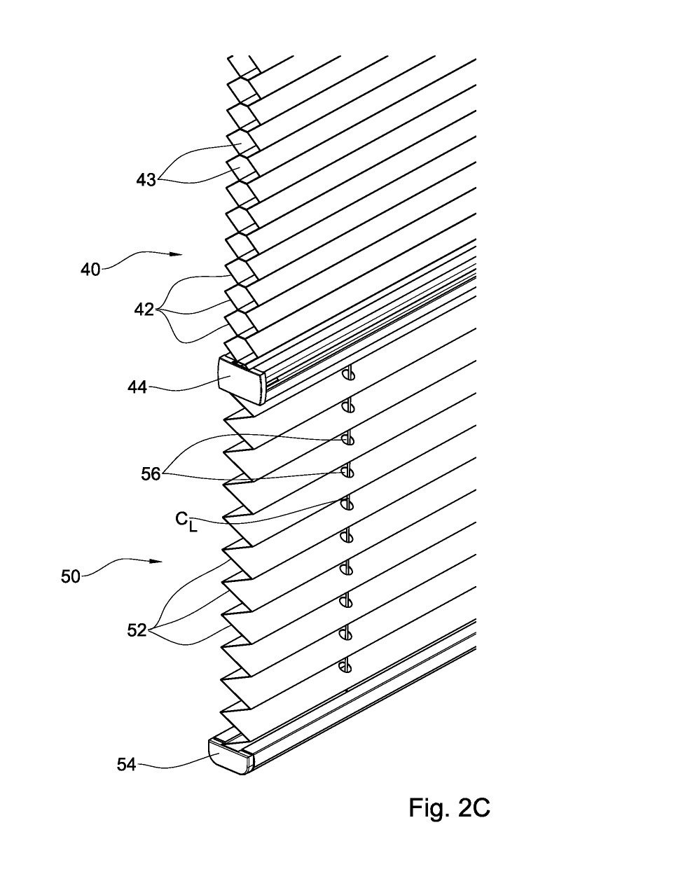

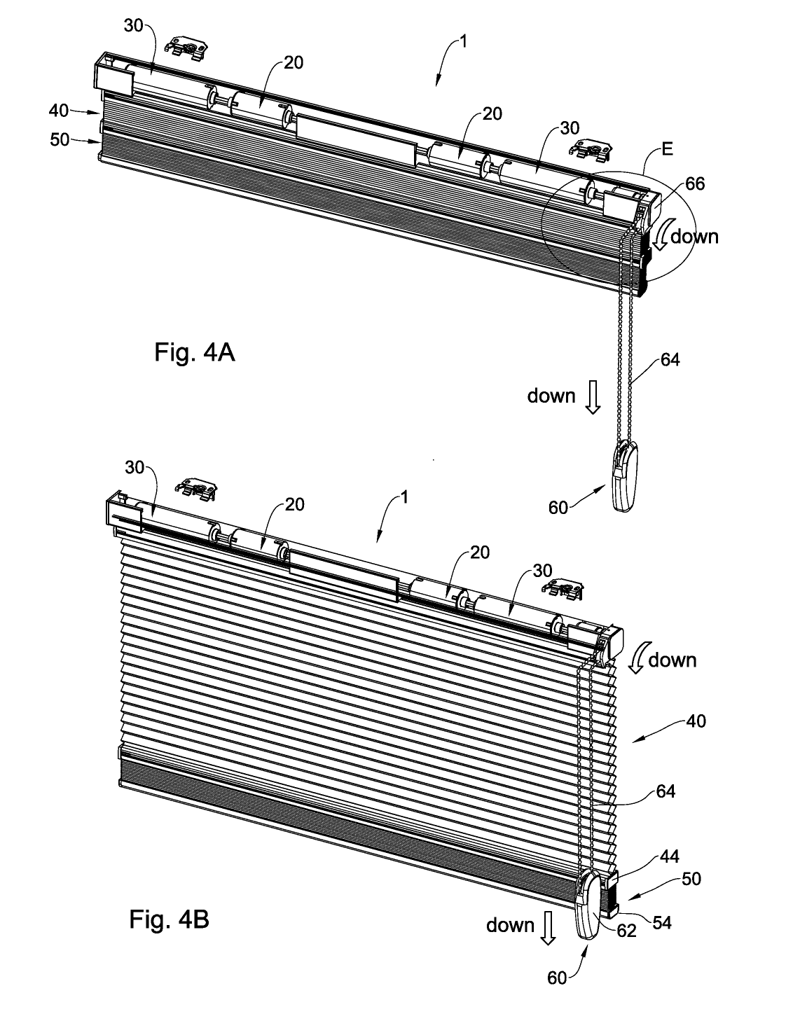

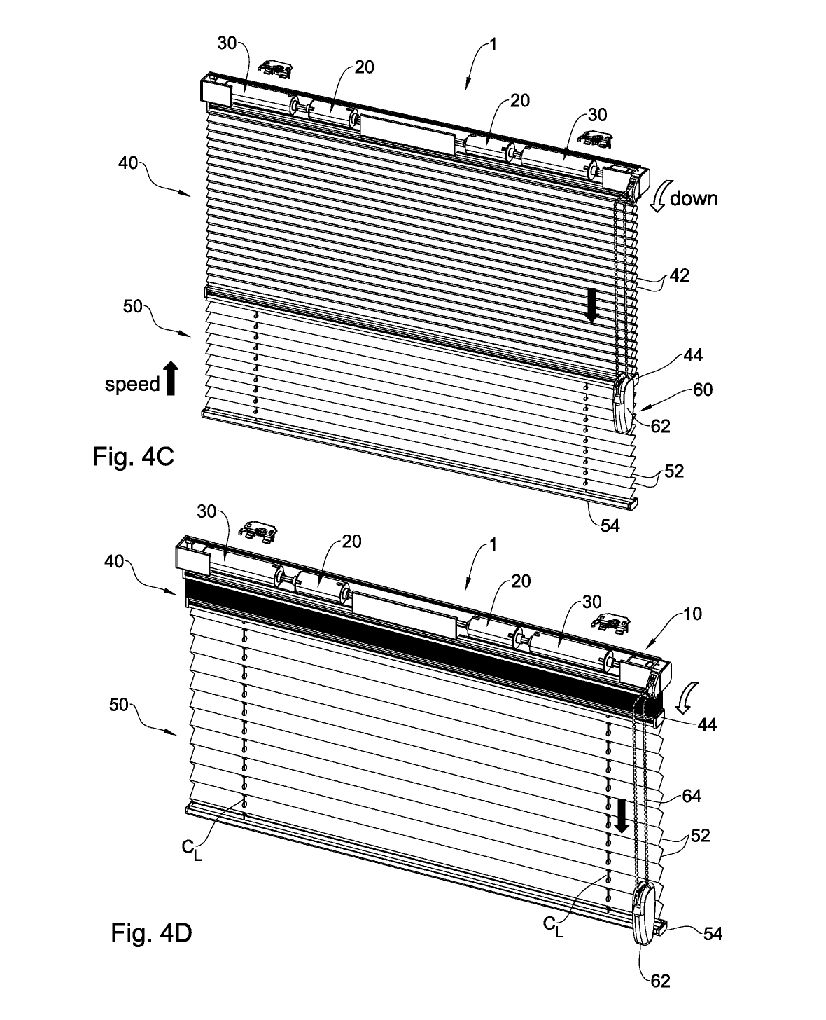

With further reference to FIGS. 2A to 2C, the cord mechanisms 20, 30 comprise respectively an upper cord C_{U} and a lower cord C_{L} (also referred to herein as 24 and 34, see FIGS. 4A to 8F), providing the association between the respective portions 40, 50 of the blind system 1.

The first portion 40 is made of a plurality of double pleats 42 while the second portion 50 is made of a plurality of single pleats 52. The arrangement is such that the upper bottom rail 44 is positioned between the headrail 10 and the lower bottom rail 54. The slats 42 of the upper portion 40 extend between the headrail 10 and the bottom rail 44 while the pleats 52 of the bottom portion 50 extend between the upper bottom rail 44 and the lower bottom rail 54.

The pleats 42, 52 are also formed with perforations 46 and 56 (obscured) configured for passage therethrough of the upper and lower cord C_{U} and C_{L}. The arrangement is such that the upper cord C_{U} extends between the upper cord mechanism 20 and the upper bottom rail 44 and has a first end attached to the former and a second end attached to the latter. The lower cord C_{L} extends between the lower cord mechanism 20 and the upper bottom rail 44 (passing through the pleats 42 of the upper portion 40) and has a first end attached to the former and a second end attached to the latter.

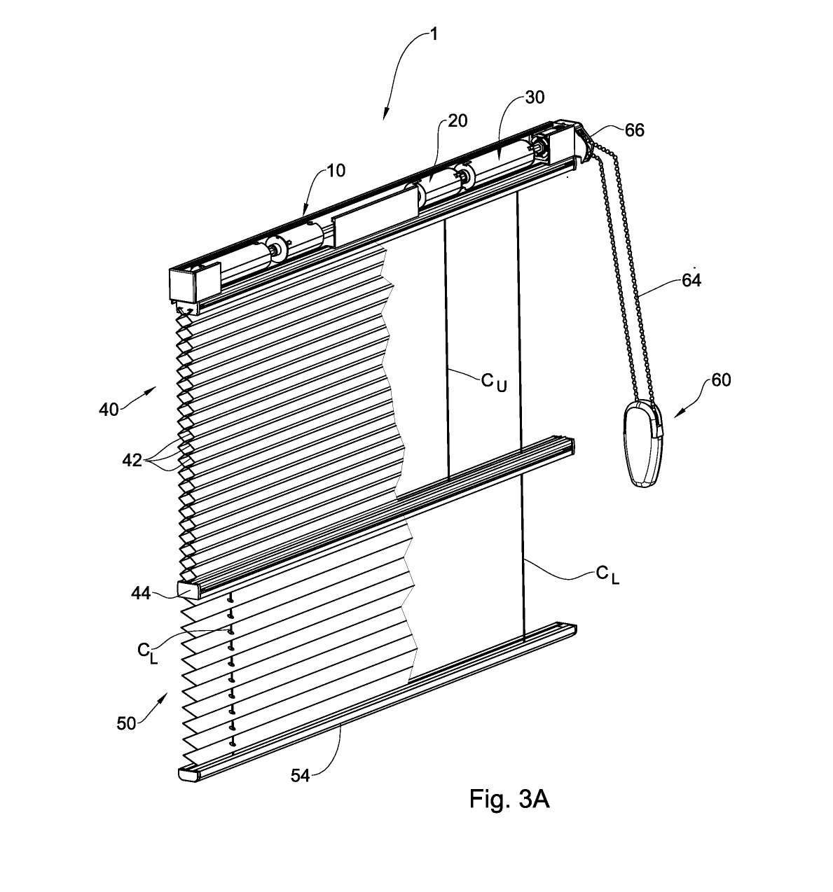

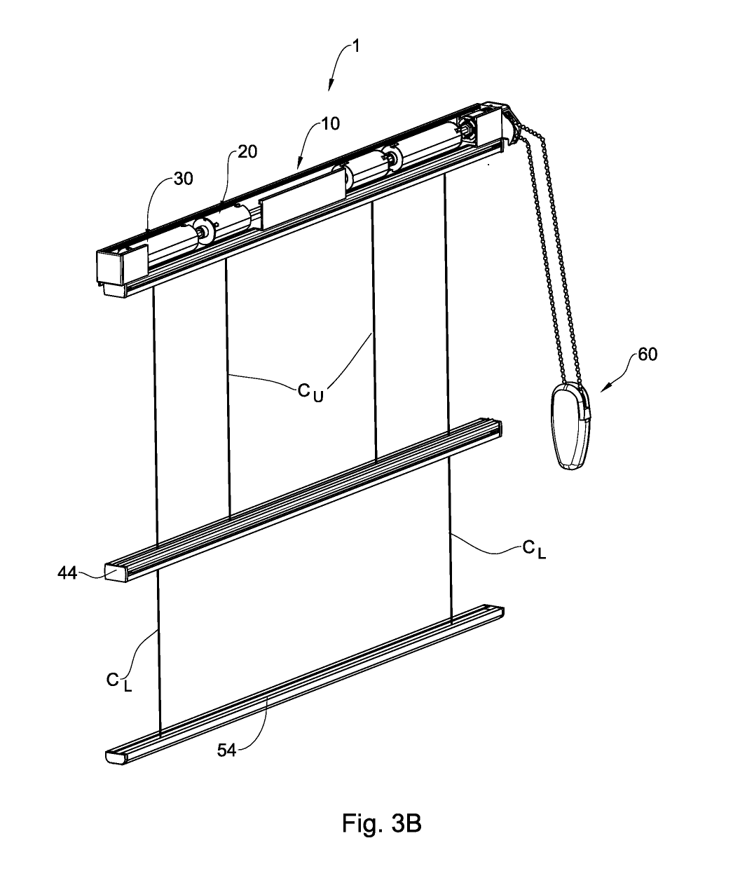

With additional reference to FIGS. 3A and 3B, it is observed that the upper cord C_{U} allows suspending the upper bottom rail 44 from the headrail 10 at a first distance therefrom and the lower cord C_{L} allows suspending the lower bottom rail 54 from the headrail at a second distance therefrom.

With reference to FIGS. 4A to 4D, the upper cord mechanism 20 comprises a spool 22 on which the upper cord 24 of length L is wound. The upper cord mechanism 20 further comprises a cap 26 and a cover 28 configured for maintaining the upper cord 24 associated with the spool 22 and preventing entanglement of the cord.

The activation mechanism 60 comprises a closed-loop notched cord 64 and a weight 62 and is associated, via a connector 66 to the mutual axis X of the cord mechanisms 20, 30. The arrangement is such that pulling on the notched cord 64 in one direction entails rotation of the mechanisms 20, 30 about the mutual axis X in a CW direction while pulling on the notched cord 64 in the opposite direction entails rotation of the mechanisms 20, 30 about the mutual axis X in a CCW direction.

The upper cord mechanism 30 comprises a spool 32 on which the upper cord 34 of length 1.5 L is wound. The upper cord mechanism 30 further comprises a cap 36 and a cover 38 configured for maintaining the upper cord 34 associated with the spool 32 and preventing entanglement of the cord.

In addition, the lower cord mechanism comprises a stopper mechanism 35 which is positioned on the cord 34 dividing the cord into a first portion defined between the first end of the cord 34 and the stopper 35 and a second portion defined between the stopper 35 and the second end of the cord 34. The arrangement is such that the stopper 35 is configured for preventing extraction of the second portion of the cord from the housing 12 of the headrail 10. It is noticed that the stopper 35 divides the second cord 34 such that the outer portion is of length L while the inner portion is only of length 0.5 L.

In FIGS. 4A to 4D, the blind system 1 is shown during various stages of its operation.

In the position shown in FIG. 4A, the system 1 is shown in its fully retracted position (initial position) in which both the upper bottom rail 44 is at a proximal position to the headrail 10 and the lower bottom rail is at a proximal position to both the headrail 10 and the upper bottom rail 44. In this position, both the upper cord 24 and the lower cord 34 are fully wound on their respective spools 22, 32.

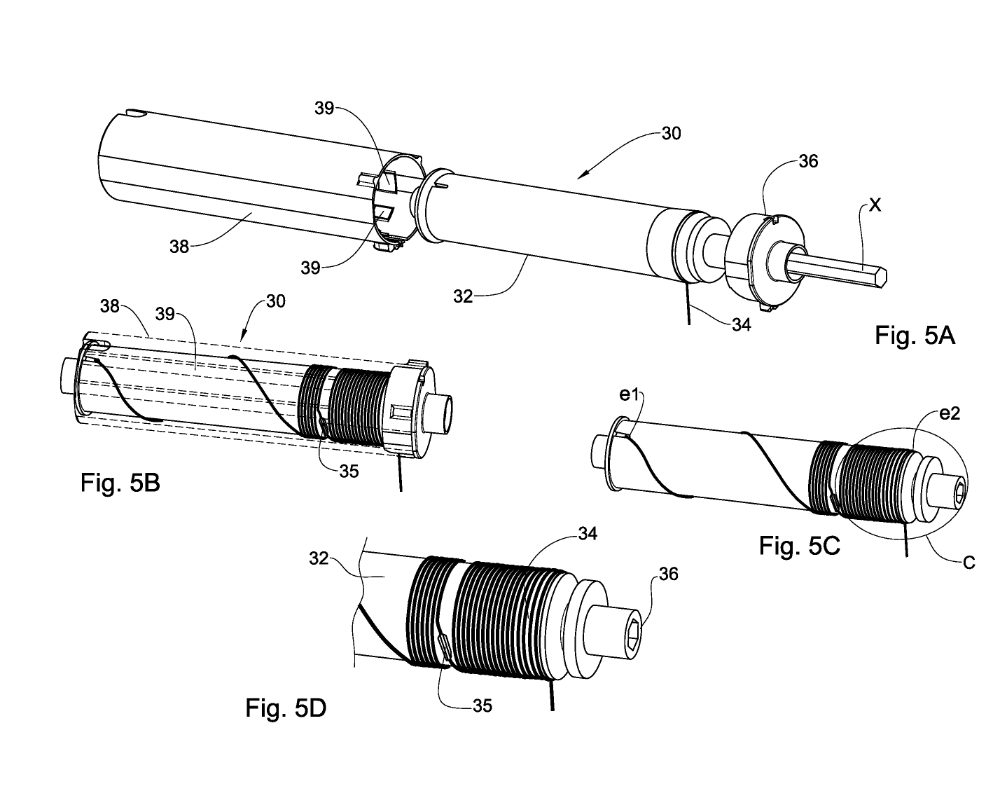

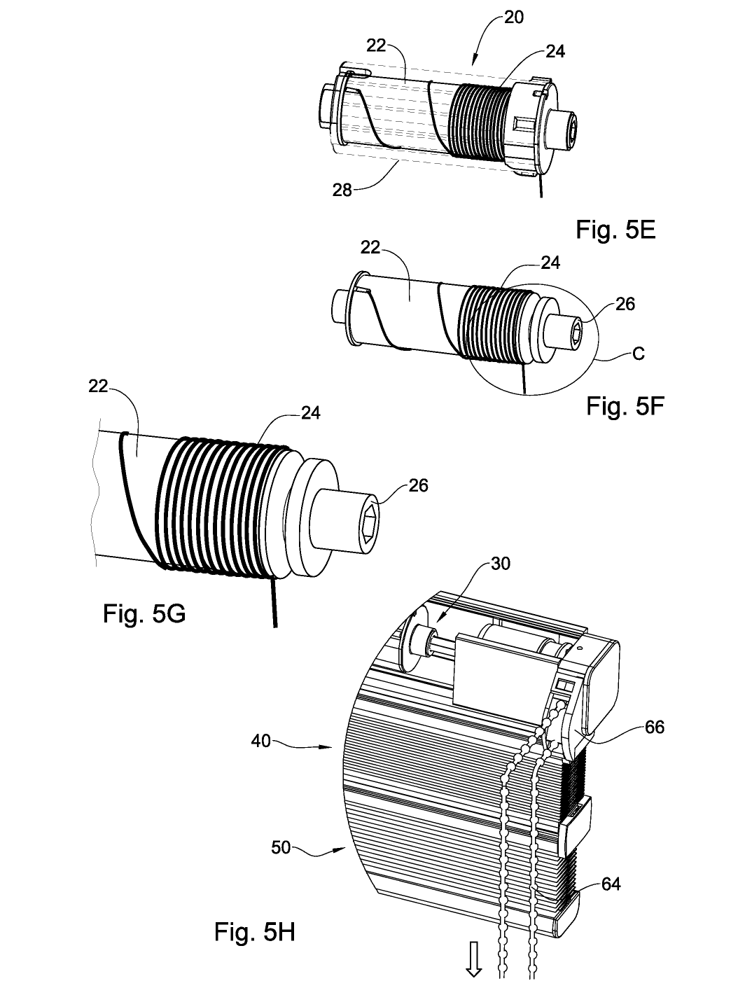

This can be further observed in FIGS. 5A to 5H, illustrating the spools 22, 32 of the upper and lower blind portions 40, 50 respectively. It is observed that the cords 24, 34 are respectively fully wound on the spools 22, 32.

Turning now to FIG. 4B, when the activation mechanism 60 is operated by pulling on the notched cord 64, the spools 22, 32 of the respective mechanisms 20, 30 are caused to revolve in a CCW direction, yielding extraction of both the upper cord 24 and the lower cord 34 through the housing 12 of the headrail 10.

Due to the CCW rotation, both the upper bottom rail 44 and the lower bottom rail 54 displace downwards simultaneously as one unit, so that the distance between the bottom rails 44, 54 remains the same as in the initial position shown in FIG. 4A. However, as the upper bottom rail 44 displaces away from the headrail 10, the pleats 42 of the upper portion 40 unfold between the upper bottom rail 44 and the headrail 10.

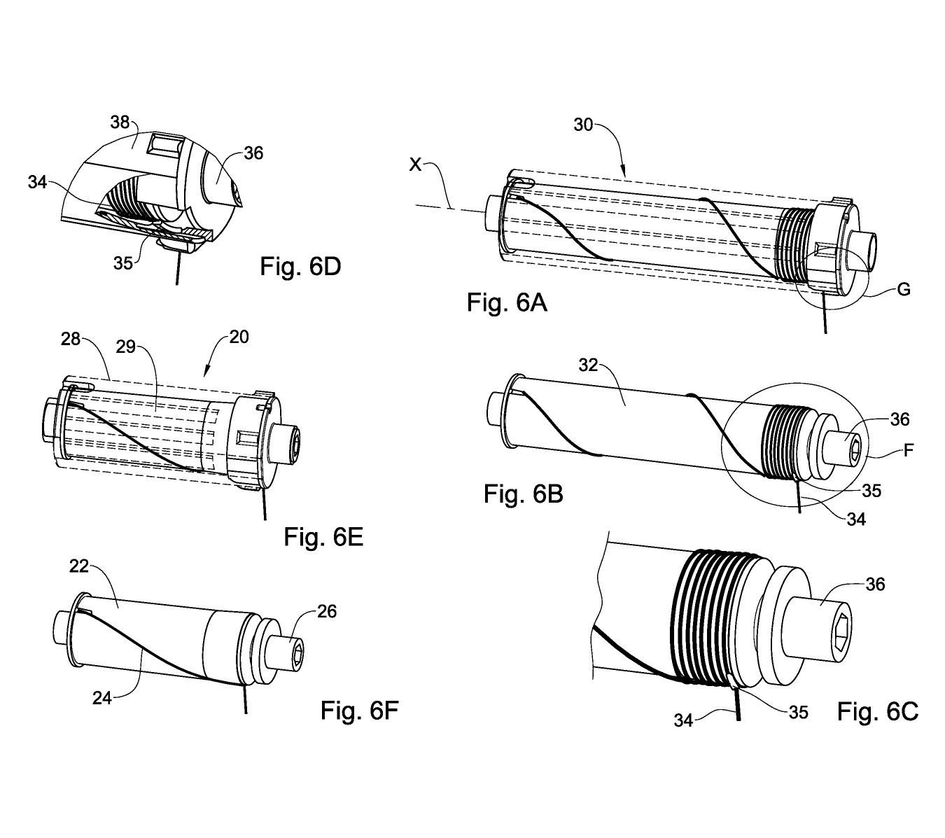

With additional reference being made to FIGS. 6A to 6F, upon completion of the stage, the upper cord 24 is completely unwound from the upper spool 22, while the lower cord 34 has its outer portion (of length L) extending fully outside the headrail 10 and its inner portion (of length 0.5 L) still wound on the spool 32. It is observed that in this position, the stopper 35 is located at the entrance of the opening of the housing 12, preventing the inner portion of the cord 34 from being pulled out of the housing 12.

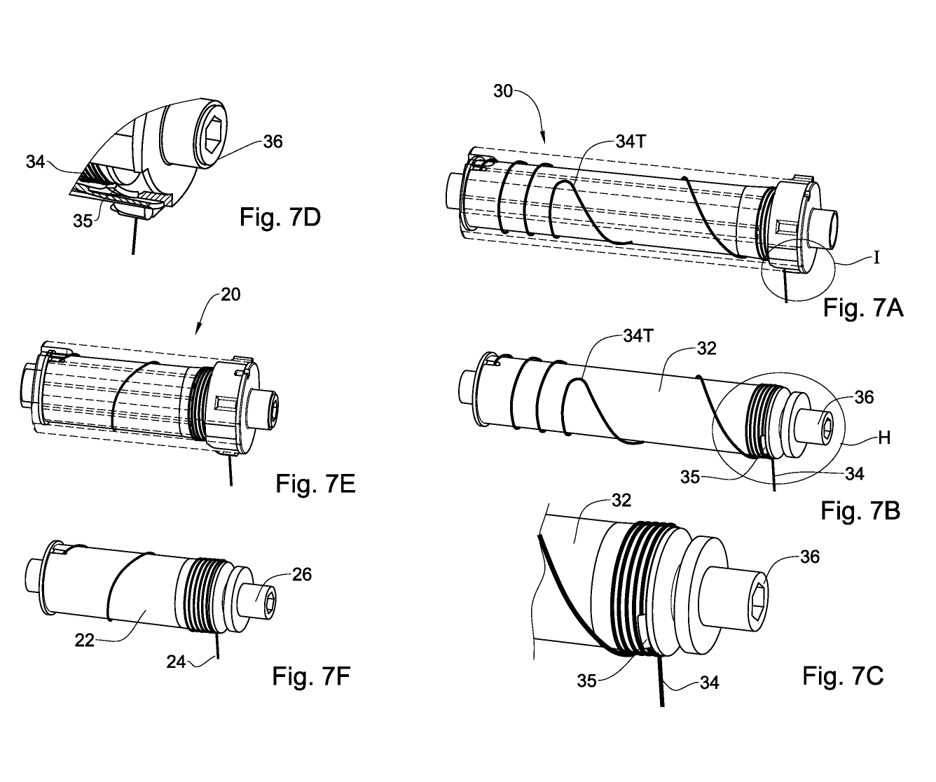

Turning now to FIG. 4C, and with additional reference to FIGS. 7A to 7F, further pulling of the notched cord 64, entails further CCW rotation of both spools 22, 32, along the longitudinal axis, and in the same direction. With respect to the spool 22, this CCW rotation entails winding of the upper cord 24 on the spool 22 in an opposite direction to that of the initial position. Such winding causes, in turn, the upper bottom rail 44 to move upwards towards the headrail 10.

Simultaneously, CCW rotation of the lower mechanism 30 entails rewinding of the inner portion of the lower cord 34 in an opposite direction. Specifically, while the end e1 of the inner portion (attached to the stopper 35) continues unwinding from the spool 32, the opposite end e2 of the inner portion (attached to the spool 32) begins winding on the spool in the opposite direction.

It is appreciated that during this stage, the inner portion of the cord 34 performs essentially a similar process as that performed by the first cord 24 in the first and second stage combined (i.e. unwinding in one direction and winding in the opposite direction). This is also the reasoning for designing a length 0.5 L for the inner portion of the cord—0.5 L of unwinding in one direction +0.5 L of winding in the opposite direction yield the desired length L equivalent to the length of the first cord 24.

It should be noted that unwinding of the inner portion of the second cord 34 in the one direction and winding thereof on the spool 32 in the opposite direction takes place simultaneously, each from an opposite end of the spool 32. This causes a twist 34T to be formed in the cord 34 during this process.

Further attention is drawn to the shell 38 of the spool, shown formed with blocking elements 39 (e.g. FIG. 5B) configured for preventing entanglement of the inner portion of the second cord 34 so that during the simultaneous unwinding and winding in the opposite direction, the inner portion of the cord 34 does not become knotted.

Throughout the above, since the stopper 35 prevents the lower cord 34 from exiting the housing 12, the lower bottom rail 54 does not displace downward and remains in the same position as shown in FIG. 4B. i.e. at a distance L from the headrail 10.

Thus, since the upper bottom rail 44 displaces towards the headrail 10 and away from the lower bottom rail 54, the pleats 42 of the upper portion 40 of the blind system 1 are folded between the headrail 10 and upper bottom rail 44 while the pleats of the lower portion 50 are unfolded between the lower bottom rail 54 and the upper bottom rail 44.

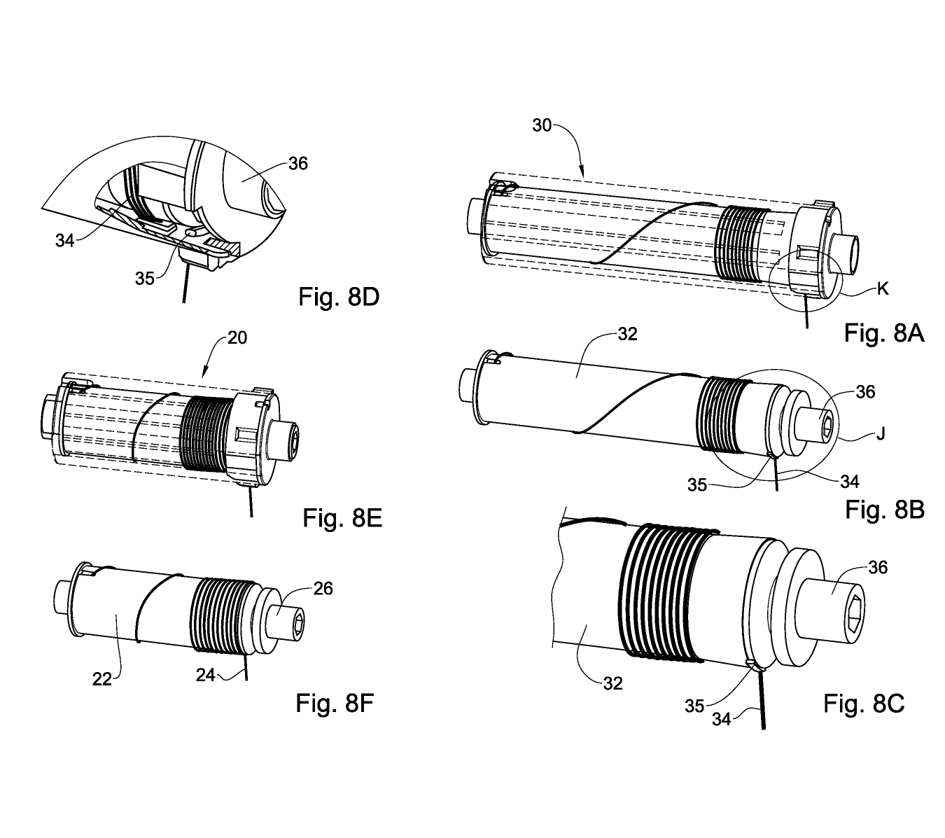

Turning now to FIG. 4D, and with additional reference to FIGS. 8A to 8F, upon completion of the previous stage, the blind system reaches its end position in which the pleats 42 of the upper portion 40 are fully folded between the headrail 10 and upper bottom rail 44 (similar to the initial position) while the pleats of the lower portion 50 are fully unfolded between the lower bottom rail 54 and the upper bottom rail 44.

In order to return to the initial position, the notched cord is pulled in the opposite direction and the entire process repeats itself in succession in reverse order.

Those skilled in the art to which this invention pertains will readily appreciate that numerous changes, variations, and modification can be made without departing from the scope of the invention, mutatis mutandis.

1. A blind system, comprising: a head-rail with a first cord mechanism associated with a first blind portion via a first cord and a second cord mechanism associated with a second blind portion via a second cord, each blind portion comprising a bottom rail, said first blind portion being interposed between said headrail and said second blind portion, wherein said second cord is also associated with said first blind portion.

2. The blind system according to claim 1, wherein the bottom rail of the first blind portion is interposed between slats/pleats of the first blind portion and slats/pleats of the second blind portion.

3. The blind system according to claim 1, wherein each of the cord mechanisms comprises a spool on which the first and second cord are respectively configured for winding.

4. The blind system according to claim 3, wherein the first and the second cord each have a proximal end fixedly attached to its respective spool and a distal end configured for attachment to a bottom rail of its respective blind portion.

5. The blind system according to claim 4, wherein each spool is configured to assume a first, fully retracted position in which its respective cord is fully wound on the spool in a predetermined direction so that the distal end of the respective cord is most adjacent to its respective spool and a second, fully deployed position in which the cord is unwound from the spool so that the distal end of the respective cord is most remote from its respective spool.

6. The blind system according to claim 5, wherein each bottom rail is configured to assume a first, proximal position in which it is at its most proximal location with respect to the headrail, and a second, distal position in which it is at its most distal location with respect to the headrail.

7. The blind system according to, claim 3, wherein the first spool is configured for assuming a third, backward retracted position in which the first cord is fully wound on the spool in a direction opposite to the predetermined direction.

8. (canceled)

9. The blind system according to claim 1, wherein a ratio between a length of the first cord and a length of the second cord is 1:1.5.

10. (canceled)

11. The blind system according to claim 1, wherein the second cord comprises a stopper disposed along the second cord and configured for dividing the second cord into an inner portion, defined between a proximal end of the second cord and the stopper and an outer portion defined between the stopper and a distal end of the second cord and wherein the stopper is configured for preventing the inner portion of the second cord from being extracted through an opening of the headrail.

12. (canceled)

13. The blind system according to claim 11, wherein the ratio between the length of the inner portion and the outer portion is 1:2.

14. The blind system according to claim 1, wherein at least the second cord mechanism further comprises a winding mechanism configured for preventing entanglement of the inner portion of the second cord.

15. The blind system according to claim 14, wherein the winding mechanism is constituted by a spool shell covering a second spool of the second cord mechanism and having block elements extending from the shell towards a spool.

16. The blind system according to claim 15, wherein the second spool is also configured for assuming a third, backward position in which the inner portion of the first cord is wound in the opposite direction on the spool.

17. The blind system according to claim 1, wherein the blind system is configured for assuming at least one of the following positions:
(a) both bottom rails are at a proximal position, closest to the headrail;
(b) the bottom rail of the first blind portion is at said proximal position while the bottom rail of the second blind portion is at a distal position, most remote from the headrail; and
(c) both bottom rails are at a distal position, most remote from the headrail.

18. The blind system according to claim 17, wherein, in position (a), the first blind portion is folded between the headrail and its respective bottom rail and the second blind portion is folded between its bottom rail and the bottom rail of the first blind portion.

19. The blind system according to claim 17, wherein, in position (b), the first blind portion is folded between the headrail and its respective bottom rail and the second blind portion is unfolded between its bottom rail and the bottom rail of the first blind portion.

20. The blind system according to claim 17, wherein, in position (c), the first blind portion is unfolded between the headrail and its respective bottom rail and the second blind portion is folded between its bottom rail and the bottom rail of the first blind portion.

21. The blind system according to claim 1, wherein the first blind portion comprises a plurality of first blind elements extending between the first bottom rail and the headrail and the second blind portion comprises a plurality of second blind elements extending between the first bottom rail and the second bottom rail.

22. (canceled)

23. The blind system according to claim 21, wherein the plurality of first blind elements and the plurality of second blind elements are of different characteristics, providing each of the blind portions with different shading characteristics.

24. (canceled)

25. The blind system according to claim 1, wherein the second cord extends from the second cord mechanism to the second bottom rail via designated openings in the first bottom rail.

26. The blind system according to claim 25, wherein displacement of the second bottom rail towards the headrail entails displacement of the first bottom rail towards the same upon contact between the bottom rails.
